(19) United States
(12) Patent Application Publication
(10) Pub. No.: US 2020/0045471 A1
(43) Pub. Date: Feb. 6, 2020

(54) SPEAKER

(71) Applicant: AAC Technologies Pte. Ltd., Singapore City (SG)

(72) Inventors: Wei Song, Shenzhen (CN); Shuwen Wu, Shenzhen (CN); Zhiyuan Chen, Shenzhen (CN); Fan Zhang, Shenzhen (CN)

(21) Appl. No.: 16/528,656

(22) Filed: Aug. 1, 2019

(30) Foreign Application Priority Data
Aug. 5, 2018 (CN) 201821255962.1

(51) Int. Cl. H04R 9/06; H04R 9/02; H04R 7/18; H04R 9/04

(52) U.S. Cl. CPC H04R 9/06; H04R 9/027; H04R 2400/11; H04R 9/04; H04R 7/18

(57) ABSTRACT

The present disclosure provides a speaker including a holder, a vibration unit and a magnetic circuit unit that are received in the holder. The vibration unit includes a voice coil, a flexible circuit board, and a diaphragm. The flexible circuit board includes a body portion and a pad portion extending inwardly from the body portion. The pad portion is electrically connected to the voice coil, and the magnetic circuit unit is provided with an avoiding portion for receiving the pad portion at a position corresponding to the pad portion. In the speaker according to the present disclosure, a local position of the flexible circuit board is connected to the voice coil, so that the magnetic gap will not be sacrificed, thereby improving the acoustic performance of the speaker and improving user experience.

### TECHNICAL FIELD

The present disclosure relates to the field of acoustic design technology, and in particular, to a speaker.

### BACKGROUND

In the related art, a speaker includes a holder and a vibration unit and a magnetic circuit unit that are received in the holder. The vibration unit includes a voice coil and a flexible circuit board electrically connected to the voice coil. In the speaker of such structure, it is conductive in the form of a lead wire, spot welding, and a holder injection-molding soldering sheet. Therefore, since a lead wire structure is provided, the product cannot be completely symmetrical and the problem of vibration imbalance is more prominent. Moreover, the lead wire structure also occupies part of the space of the magnetic gap, resulting in a decrease in the acoustic performance of the speaker.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exploded diagram of a speaker of the present disclosure;

FIG. 2 is a perspective diagram of a speaker of the present disclosure;

FIG. 3 is a cross-sectional diagram of the speaker shown in FIG. 2 taken along line AA.

### DESCRIPTION OF EMBODIMENTS

The present disclosure will be further illustrated with reference to the accompanying drawings and the embodiments.

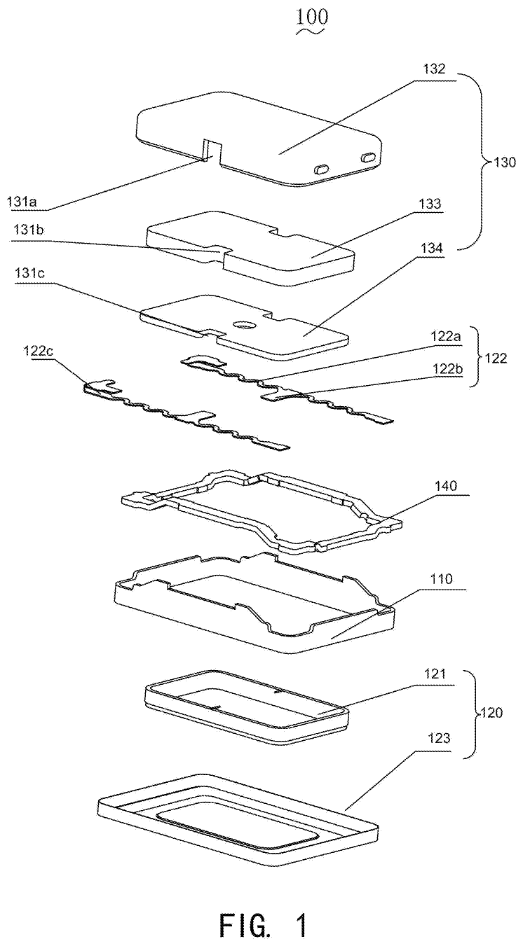

As shown in FIG. 1 to FIG. 3, the present disclosure relates to a speaker 100. The speaker 100 includes a holder 110, and a vibration unit 120 and a magnetic circuit unit 130 that are received in the holder 110. The vibration unit 120 includes a voice coil 121, a flexible circuit board 122, and a diaphragm 123. The flexible circuit board 122 includes a body portion 122a and a pad portion 122b extending inwardly from the body portion 122a. The pad portion 122b is electrically connected to the voice coil 121, and the magnetic circuit unit 130 is provided with an avoiding portion 131 for receiving the pad portion 122b at a position corresponding to the pad portion 122b.

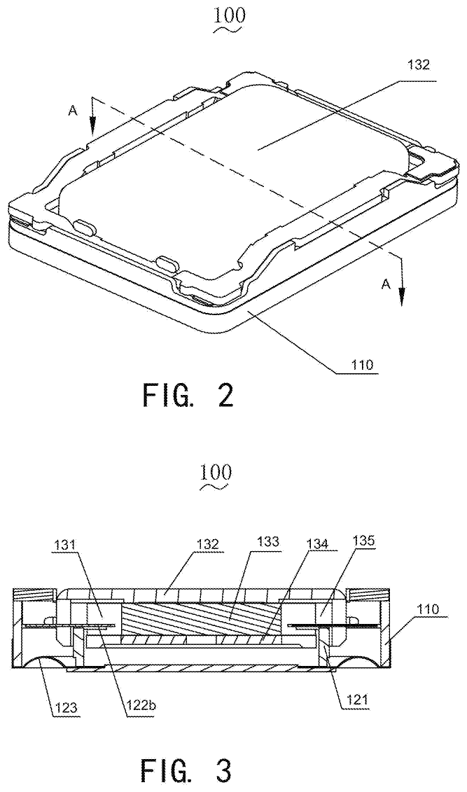

Specifically, as shown in FIGS. 1 and 2, when the flexible circuit board 122 is electrically connected to the voice coil 121, the pad portion 122b extending towards the magnetic circuit unit 130 may be caused to be electrically connected to the voice coil 121, so that electrical connection of the flexible circuit board 122 to the voice coil 121 can be achieved. Namely, only part of the flexible circuit board 122 is electrically connected to the voice coil 121, and in this way, the magnetic gap will not be sacrificed, thereby improving the acoustic performance of the speaker 100.

In the speaker 100 in the present embodiment, the flexible circuit board 122 includes the pad portion 122b extending towards the magnetic circuit unit 130 and connected to the voice coil and the magnetic circuit unit 130 is provided with the avoiding portion 131 for receiving the pad portion 122b at a position corresponding to the pad portion 122b. In the speaker 100 in the present embodiment, a local position of the flexible circuit board 122 is connected to the voice coil 121, so that the magnetic gap will not be sacrificed, thereby improving the acoustic performance of the speaker 100 and improving user experience.

As shown in FIG. 1 and FIG. 3, the flexible circuit board 122 has a strip structure, and there are two flexible circuit boards 122 symmetrically provided on two sides of the magnetic circuit unit 130.

Specifically, as shown in FIG. 1 and FIG. 3, the flexible circuit board 122 is provided on two sides of a long axis end of the magnetic circuit unit 130. The flexible circuit board 122 is located between the magnetic circuit unit 130 and the holder 110.

The two flexible circuit boards 122 may be located on two sides of a short axis end of the magnetic circuit unit 130 in addition to being located on the two sides of the long axis end of the magnetic circuit unit 130.

As shown in FIGS. 1 and 3, the flexible circuit board 122 is located at the bottom of the voice coil 121, and the pad portion 122b is at least partially located inside the voice coil 121. Namely, as shown in FIGS. 1 and 3, the pad portion 122b laterally straddles the voice coil 121, i.e., the pad portion 122b is dividedly provided on the inner and outer sides of the voice coil 121, and the pad portion 122b is bonded to the bottom of the voice coil 121. Thus, when the pad portion 122b is bonded to the voice coil 121, a bonding area between the voice coil 121 and the pad portion 122b can be increased, thereby improving the stability of the electrical connection of the pad portion 122b to the voice coil 121. Without doubt, in addition to bonding, the pad portion 122b may be electrically connected to the voice coil 121 by other fixing methods, such as welding.

As shown in FIGS. 1 and 3, the pad portion 122b is located at a middle position of the magnetic circuit unit 130 in a length direction. Accordingly, the magnetic circuit unit 130 is provided with the avoiding portion 131 at a middle position along its length direction.

Without doubt, beyond that, the pad portion 122b may also be located at any position along the length direction of the magnetic circuit unit 130. When the pad portion 122b is located at the middle position of the magnetic circuit unit 130 in the length direction, the structure of the speaker 100 can be completely symmetrical and the problem of vibration imbalance can be effectively solved, thereby making the acoustic performance of the speaker 100 better.

As shown in FIG. 1 and FIG. 3, the magnetic circuit unit 130 includes a magnetic frame 132 and a main magnet 133 and a pole plate 134 that are provided in the magnetic frame 132 in sequence. There is a magnetic gap 135 between the main magnet 133, the pole plate 134 and the magnetic frame 132, and the voice coil 121 is inserted in the magnetic gap 135. Moreover, the avoiding portion 131 includes a first avoiding portion 131a provided on the magnetic frame 132, a second avoiding portion 131b provided on the main magnet 133, and a third avoiding portion 131c provided on the pole plate 134.

Specifically, the magnetic frame 132, the main magnet 133, and the pole plate 134 are provided with an avoiding slot penetrating through their respective thicknesses at a position corresponding to the pad portion 122b. The opening end of the avoiding slot faces towards the pad portion 122b, and the avoiding slot forms the avoiding portion 131.

Thus, when assembling the speaker 100 of the above structure, the pad portion 122b of the flexible circuit board 122 can be placed in the avoiding slot, and a lower surface of the pad portion 122b is electrically connected to the voice coil 121. Therefore, in the speaker 100 in the present embodiment, a local position of the flexible circuit board 122 is connected to the voice coil 121, so that the magnetic gap 135 will not be sacrificed, thereby improving the acoustic performance of the speaker 100 and improving user experience.

It should be noted that there is no limitation on the shape of the avoiding slot. For example, a longitudinal section of the avoiding slot may have a structure of a triangular shape, a trapezoidal shape, or a rectangular shape and the like. Accordingly, the shape of the pad portion 122b should match the shape of the avoiding slot.

As shown in FIG. 1 and FIG. 3, the speaker 100 is further provided with a conductive ring 140 connected to an end of the holder 110 facing away from the diaphragm 123. The flexible circuit board 122 is provided with a fixing slot 122c. The fixing slot 122c is connected with the conductive ring 140 to fixedly connect the conductive ring 140 to the flexible circuit board 122.

What has been described above is only an embodiment of the present disclosure, and it should be noted herein that one ordinary person skilled in the art can make improvements without departing from the inventive concept of the present disclosure, but these are all within the scope of the present disclosure.

What is claimed is:

1. A speaker, comprising:
a holder;
a vibration unit received in the holder; and
a magnetic circuit unit received in the holder,
wherein the vibration unit comprises a voice coil, at least one flexible circuit board and a diaphragm, each of the at least one flexible circuit board comprises a body portion and a pad portion extending inwardly from the body portion, the pad portion is electrically connected to the voice coil, and the magnetic circuit unit is provided with an avoiding portion for receiving the pad portion at a position corresponding to the pad portion.

2. The speaker as described in claim 1, wherein each of the at least one flexible circuit board has a strip structure, and the at least one flexible circuit comprises two flexible circuit boards symmetrically provided on two sides of the magnetic circuit unit.

3. The speaker as described in claim 2, wherein the two flexible circuit boards are provided on two sides of a long axis end of the magnetic circuit unit, and the two flexible circuit boards are located between the magnetic circuit unit and the holder.

4. The speaker as described in claim 1, wherein the at least one flexible circuit board is located at a bottom of the voice coil, and the pad portion is at least partially located inside the voice coil.

5. The speaker as described in claim 4, wherein the pad portion is bonded to the bottom of the voice coil.

6. The speaker as described in claim 1, wherein the pad portion is located at a middle position of the magnetic circuit unit in a length direction.

7. The speaker as described in claim 1, wherein the magnetic circuit unit comprises a magnetic frame and a main magnet provided in the magnetic frame, a magnetic gap is provided between the main magnet and the magnetic frame, the voice coil is inserted in the magnetic gap, and the avoiding portion comprises a first avoiding portion provided on the magnetic frame and a second avoiding portion provided on the main magnet.

8. The speaker as described in claim 7, wherein the magnetic circuit unit further comprises a pole plate provided on the main magnet, and the avoiding portion further comprises a third avoiding portion provided on the pole plate.

9. The speaker as described in claim 1, wherein the speaker is further provided with a conductive ring connected to an end of the holder facing away from the diaphragm, the flexible circuit board is provided with a fixing slot, and the fixing slot is connected with the conductive ring to fixedly connect the conductive ring to the at least one flexible circuit board.
